(19) United States
(12) Patent Application Publication
(10) Pub. No.: US 2006/0280046 A1
(43) Pub. Date: Dec. 14, 2006

(54) Picture display apparatus

(75) Inventors: Yuuichi Togashi, Suginami-ku (JP); Naruki Nakase, Oume-shi (JP); Kouichi Ogi, Hanno-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/394,240

(22) Filed: Mar. 31, 2006

(30) Foreign Application Priority Data
Mar. 31, 2005 (JP) P2005-105178

(51) Int. Cl. G11B 21/08

(52) U.S. Cl. 369/30.01

(57) ABSTRACT

According to one embodiment, a picture display apparatus includes: a user information acquisition unit that acquires user information that is displayed when the picture display apparatus is powered on next time; a memory that stores the user information at the time of powering off the picture display apparatus, the user information acquired by the user information acquisition unit; and a display unit that displays the user information stored in the memory during a start-up process at the time of powering on the picture display apparatus.

### CROSS-REFERENCE TO RELATED APPLICATIONS

This application is based upon and claims the benefit of priority from Japanese Patent Application No. 2005-105178, filed Mar. 31, 2005, the entire contents of which are incorporated herein by reference.

### BACKGROUND

1. Field

One embodiment of the invention relates to a picture display apparatus for recording/reproducing pictures of a television program, etc.

2. Description of the Related Art

Generally, a screen backed with blue called “blue-back screen” or a maker logo screen is displayed on a picture display apparatus such as a television set during an initializing process at the time of powering on the picture display apparatus or when a picture screen other than an input signal needs to be displayed at the time of powering off the picture display apparatus or at the time of inputting no signal.

However, a user could not feel any particular merit of the blue-back screen or maker logo screen.

Therefore, JP-A-2003-202851 has disclosed an apparatus including nonvolatile storage means used as rewritable means for storing an image to be displayed, and rewriting means for rewriting information stored in the storage means on the basis of information input from the outside so that the image can be displayed in compliance with the user's wishes.

According to the apparatus disclosed in JP-A-2003-202851, the name of a user purchasing a display apparatus such as a projector, particularly the name of a merchant's company or shop, can be displayed in place of the maker logo to improve the effect of advertising the company in a meeting or business talk to a customer to thereby increase the utility value for the user.

There is, however, a problem that an end user who does not expect the advertising effect cannot gain any particular merit from the apparatus disclosed in JP-A-2003-202851. Even if the end user could use an image on the display screen by rewriting the image in compliance with the user's wishes, the image cannot provide meaningful information to the user because the image is patterned.

The invention is achieved based on this background. An object of the invention is to provide a picture display apparatus for providing meaningful information to a user during an initializing process at the time of powering on the picture display apparatus.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a view showing the overall configuration of a schedule function in a picture apparatus.

FIG. 2 is a block diagram showing the configuration of a recording/reproducing apparatus.

FIG. 3 is a view showing an example of a screen of a program list.

FIG. 4 is a view showing an example of a recording-reservation list.

FIG. 5 is a flow chart for explaining acquisition of notice information.

FIG. 6 is a view showing an example of inputting of a schedule.

FIG. 7 is a flow chart for explaining a power-off process.

FIG. 8 is a flow chart for explaining a power-on process.

### DETAILED DESCRIPTION

Various embodiments according to the invention will be described hereinafter with reference to the accompanying drawings. In general, according to one embodiment of the invention, a picture display apparatus includes: a user information acquisition unit that acquires user information at the time of powering off the picture display apparatus, the user information to be displayed when the picture display apparatus is powered on next time; a memory that stores the user information acquired by the user information acquisition unit; and a display unit that displays the user information stored in the memory during a start-up process at the time of powering on the picture display apparatus.

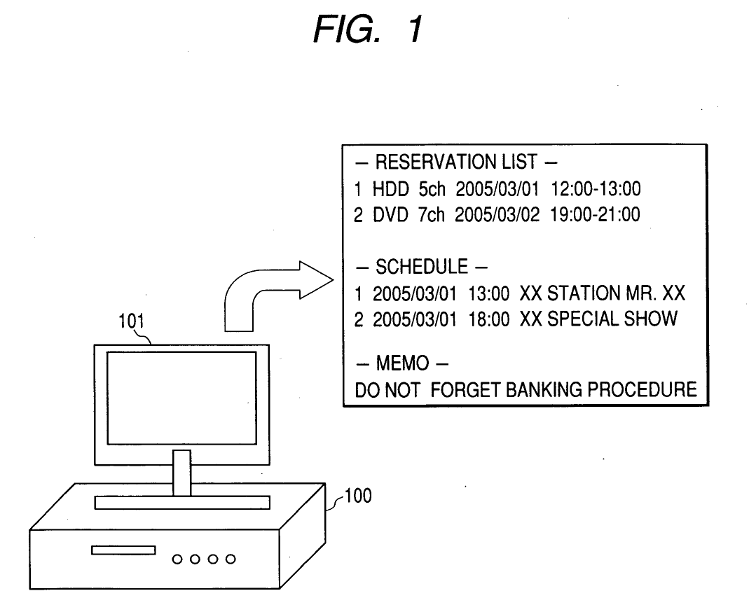

According to an embodiment, FIG. 1 is a view showing the overall configuration of a recording/reproducing apparatus 100 as a picture display apparatus in a state in which the recording/reproducing apparatus 100 is used.

The recording/reproducing apparatus 100 performs recording/reproduction of television broadcast programs. Pictures output from the recording/reproducing apparatus 100 are supplied to a picture apparatus 200 such as a television receiver or a monitor and displayed by the picture apparatus 200.

A list of information reserved in the recording/reproducing apparatus 100 and notice information such as user's schedules and memos are acquired at the time of powering off the recording/reproducing apparatus 100 so that the list of reserved information and the list of schedules and memos as shown in FIG. 1 can be displayed on the picture apparatus 200 during a start-up process at the time of powering on the recording/reproducing apparatus 100 next time.

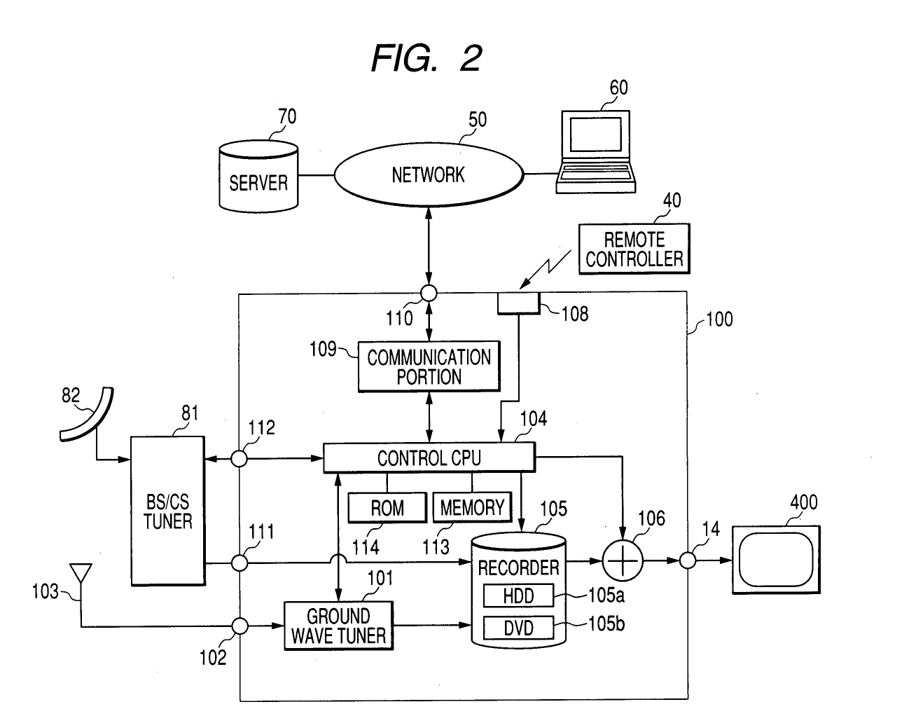

FIG. 2 is a block diagram showing the configuration of the recording/reproducing apparatus 100. The recording/reproducing apparatus 100 includes a built-in tuner 101. The tuner 101 is supplied with a signal received from a receiving antenna 103 connected to an antenna terminal 102.

Electronic program guide (hereinafter abbreviated to “EPG”) data superposed on an analog television signal received and decoded by the built-in tuner 101 of the recording/reproducing apparatus 100 are extracted from the analog television signal and supplied to a control CPU 104 to form the EPG.

For example, the formed EPG is used for setting the broadcast time zones, the broadcast channels, etc. of desired programs to be recorded. The built-in tuner 101 is supplied with a channel selection control signal or the like while a recorder 105 serving as recording means is driven in accordance with the contents of the settings.

In this manner, video and audio signals in the television signal received and decoded by the built-in tuner 101 are recorded in the recorder 105. Incidentally, although well-known A/D or D/A conversion, etc. is performed in the recording/reproducing operation of the recorder 105, details thereof will be omitted here. The recorder 105 has a built-in HDD 105a as a large-capacity storage device, so that long-time program recording can be performed by the recorder 105.

The video and audio signals in the television signal recorded in the recorder 105 are reproduced in accordance with control of the control CPU 104 and taken out to an output terminal 107 through a mixer 106. These signals taken out to the output terminal 107 are fed to the picture apparatus 200, so that the picture signal is displayed on the picture apparatus 200 while the audio signal is output as sound.

An image of the EPG formed by the control CPU 104 and an image of another operation guide are supplied to the mixer 106 and superposed on the video signal reproduced by the recorder 105. In this manner, the images of the EPG, the other operating guide, etc. can be displayed on the screen of the picture apparatus 200 while the images are superposed on the video signal received by the picture apparatus 200.

The recording/reproducing apparatus 100 can be controlled by a remote controller 40 regardless of whether the images of the EPG, the other operation guide, etc. are viewed or not. Incidentally, the control is performed in such a manner that a remote control receiver 108 receives a signal from the remote controller 40, and that the received signal is supplied to the control CPU 104.

Further, a connection terminal 110 from a communication portion 109 which is one of constituent members of the recording/reproducing apparatus 100 is connected to a personal computer 60 through a network 50, so that various kinds of information can be input/output to/from the personal computer 60 through the connection terminal 110. Moreover, configuration is made so that information can be also acquired from a server 70 connected to the network 50 through the connection terminal 110.

A satellite broadcast BS/CS tuner 81 can be externally connected to the recording/reproducing apparatus 100, so that video and audio signals output from the BS/CS tuner 81 can be received from an input terminal 111. In addition, data can be exchanged between the recording/reproducing apparatus 100 and the BS/CS tuner 81 through a terminal 112. Specifically, electronic program guide (hereinafter abbreviated to “EPG”) data are extracted from a digital television signal received and decoded by the BS/CS tuner 81 and are supplied to the control CPU 104 through the terminal 112 to form the EPG. Moreover, the control CPU 104 supplies a channel selection control signal to the BS/CS tuner 81 through the terminal 112 in accordance with the user's operation.

Incidentally, the BS/CS tuner 81 is connected to a satellite broadcast receiving antenna 82, so that a signal received from the antenna 82 can be supplied to the BS/CS tuner 81. A nonvolatile memory 113, which is smaller in capacity than the HDD 105a, is connected to the control CPU 104. Information is stored in the memory 113 or HDD 105a so that the information can be displayed during the start-up process at the time of powering on the recording/reproducing apparatus 100.

In addition, a memory 114 for storing programs is connected to the control CPU 104. The control CPU 104 operates in accordance with the programs stored in the memory 114. A menu, etc. of the recording/reproducing apparatus 100 is also formed from the programs stored in the memory 114.

The recording/reproducing apparatus 100 can record television programs received and decoded by the tuner 101 and the BS/CS tuner 81. The user can also use the remote controller 40 to reserve timer-recording while viewing the EPG.

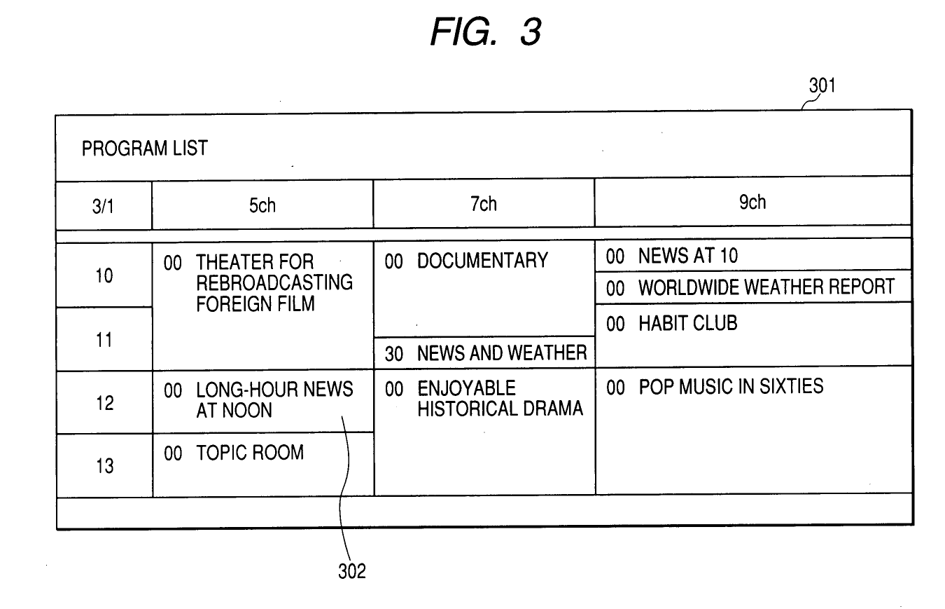

When EPG data are acquired so that the EPG is formed by the control CPU 104 in the recording/reproducing apparatus 100, for example, an image of the EPG 301 as shown in FIG. 3 is displayed on the picture apparatus 200.

When the user selects a program from the EPG 301 displayed on the picture apparatus 200 in compliance with the user's wishes, recording-reservation information of the selected program is stored in the memory 113. When, for example, a program named “long-hour news at noon” is selected from the EPG 301 shown in FIG. 3 for record reservation, not only title but also channel, date, broadcast start time, broadcast termination time, recording destination (HDD 105a or DVD 105b) where the program is to be recorded, recording mode, image rate, etc. of the program “long-hour news at noon” are stored as recording-reservation information in the HDD 105a and the memory 113.

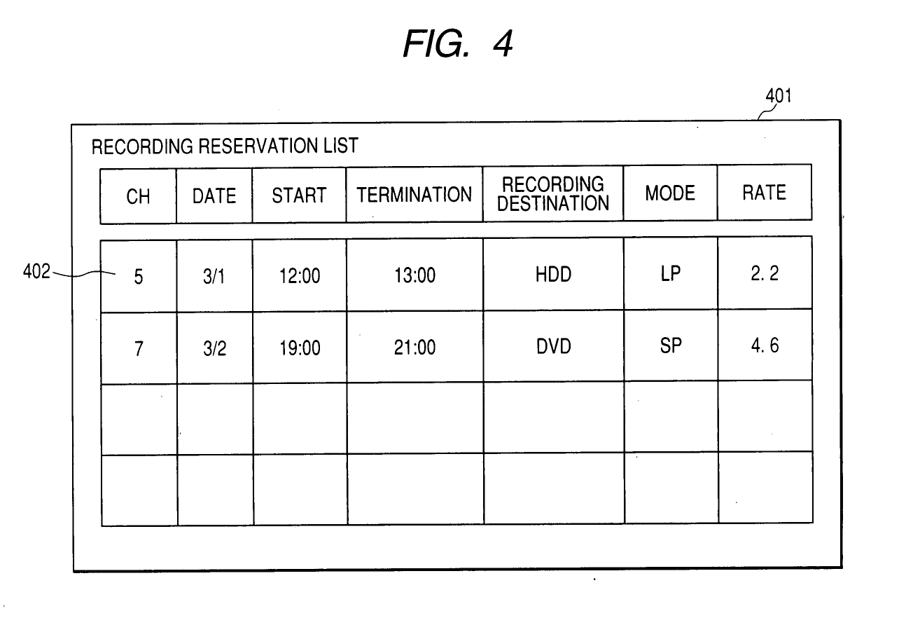

When the user selects display of a reservation list, the control CPU 104 reads the recording-reservation information stored in the HDD 105a or the memory 113, forms a list 401 of recording-reservations shown in FIG. 4 and displays the list 401 on the picture apparatus 200. When the user wants to delete a specific program from the reservation list, the user can select the program to be deleted by using the remote controller 40 to delete the recording reservation of the selected program. When, for example, the user wants to delete reservation information 402 of Channel 5, March 1, 12:00-13:00 from the recording-reservation list 401 shown in FIG. 4, the user moves the cursor onto the reservation information 402 by using the remote controller 40 to delete the reservation information 402.

When it comes to the time for the recording-reservation information stored in the HDD 105a or memory 113 in accordance with output from a timer not shown, the control CPU 104 starts recording based on the recording-reservation information.

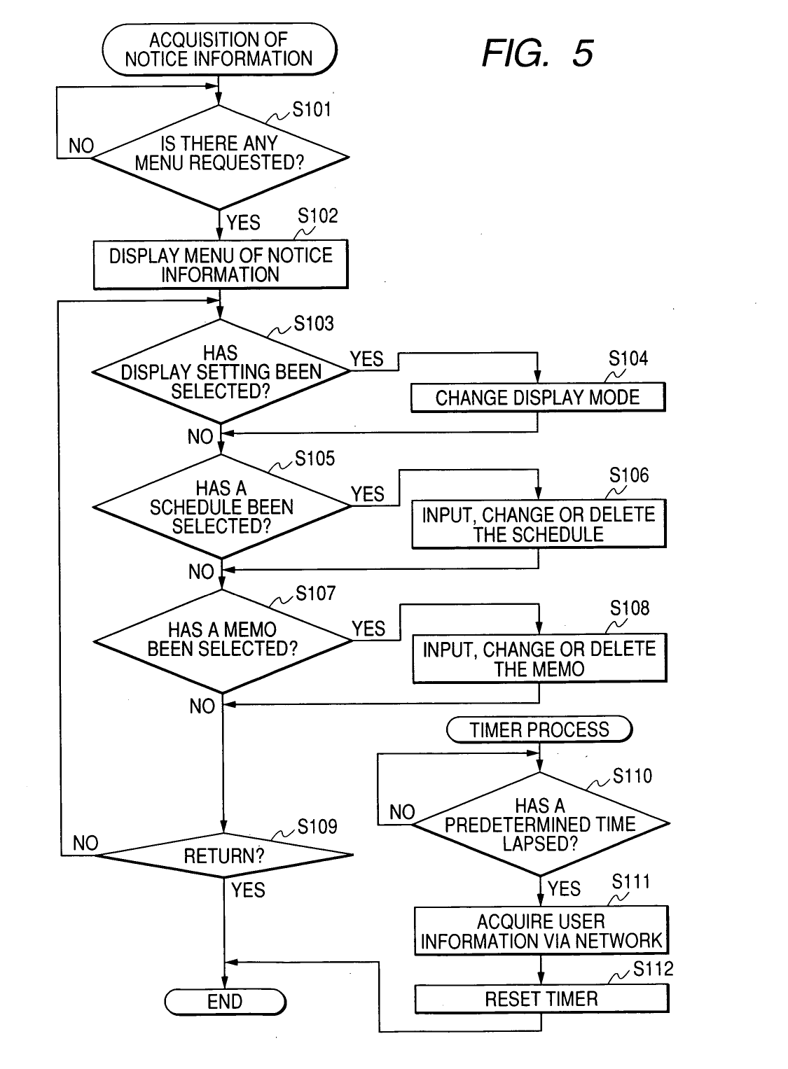

Next, notice information processing performed by the recording/reproducing apparatus 100 will be described in accordance with flow charts of FIGS. 5 to 7. FIG. 5 is a flow chart showing an operation for acquiring notice information ordinarily when the recording/reproducing apparatus 100 is operative. The recording/reproducing apparatus 100 prepares menus for inputting, changing or deleting information such as user's schedules and memos in accordance with the programs shored in the ROM 114. When a notice information menu is selected by remote-control keys, etc. of the remote controller 40 while the recording/reproducing apparatus 100 is operative (S101), the notice information menu is displayed (S102).

Though not shown, the notice information menu is a menu not only for inputting, changing and deleting information such as user's schedules and memos, etc. but also for performing display setting. The control CPU 104 judges whether the display setting has been-selected or not (S103). When the display setting has been selected, the user sets whether notice information should be displayed at the time of powering on the recording/reproducing apparatus 100, so that display mode setting information for indicating whether the notice information should be displayed is stored in the memory 113 (S104).

Successively, the control CPU 104 judges whether a schedule has been selected or not (S105). When the schedule has been selected, the user operates the remote controller 40 to input, change or delete the user's schedule information, so that the schedule information is stored in the HDD 105a (S106).

Further, the control CPU 104 judges whether a memo has been selected or riot (S107). When the memo has been selected, the user operates the remote controller 40 to input, change or delete the user's memo information, so that the memo information is stored in the HDD 105a (S108).

When inputting, changing or deletion of information such as a schedule or a memo is completed, the user operates a return button (not shown) of the remote controller 40. When the control CPU 104 detects the operation of the return button (S109), the operation for acquiring the notice information is terminated.

Separately from the operation for acquiring the notice information, the recording/reproducing apparatus 100 acquires notice information automatically at intervals of a predetermined time during the start-up operation of the recording/reproducing apparatus 100. The control CPU 104 always works to operate a soft timer not only during the start-up operation of the recording/reproducing apparatus 100 (at the time of powering on the recording/reproducing apparatus 100) but also during the stop operation of the recording/reproducing apparatus 100 (at the time of powering off the recording/reproducing apparatus 100).

The control CPU 104 monitors whether a predetermined time has lapsed or not since the previous automatic acquisition of the notice information in accordance with the soft timer (ST110). When the predetermined time has lapsed, the control CPU 104 acquires user information through the network (ST111).

As for the acquisition of user information through the network, the communication portion 109 communicates with a home personal computer 60 connected to the communication portion 109 through the network 50 to acquire schedule information and memo information stored in the personal computer 60. Further, configuration may be made so that the communication portion 109 communicates with an out-of-home server 70 connected to the communication portion 109 through the network 50 to acquire information such as a recording reservation mail, a memo information mail, a schedule information mail, etc. stored in the server 70 through the connection terminal 110.

Therefore, the user sends a mail in a predetermined format to the user's mail address of the server 70 in advance. Such information acquisition is generally popular as a recording reservation mail using a cellular phone. When this information acquisition is expanded into not only the recording-reservation mail but also the memo information mail and the schedule information mail, the user can send the user information to the recording/reproducing apparatus 100 from a place out of home.

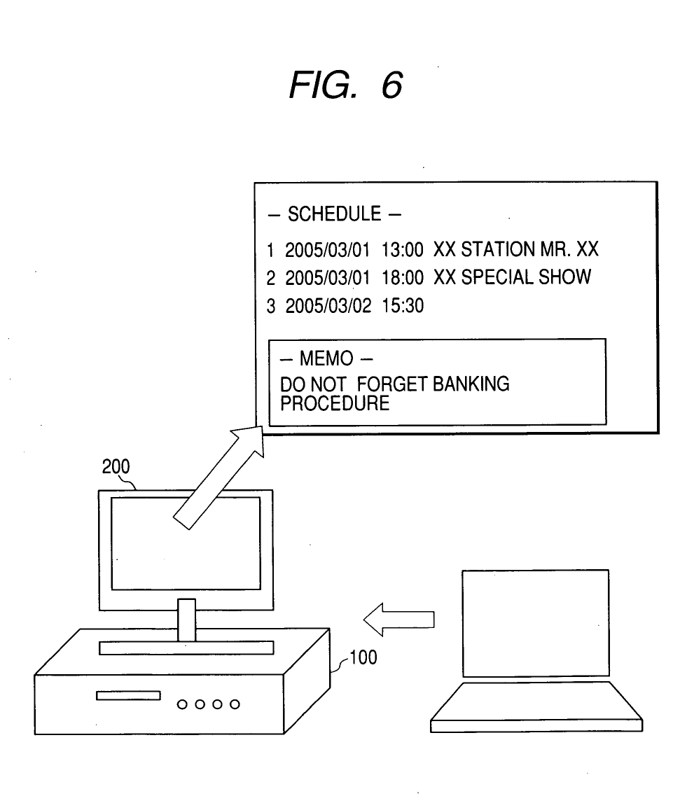

FIG. 6 is view showing an example of inputting of a schedule. In this example, inputting, changing and deletion can be performed on a schedule number selected from display contents in an upper part of the picture apparatus 200. Moreover, a necessary memo can be input, changed and deleted in a frame of display contents in a lower part of the picture apparatus 200.

A keyboard displayed on the picture apparatus 200 is used for inputting information. When the recording/reproducing apparatus 100 supports a network, information may be input from a personal computer, etc. or an electronic mail in a determined format may be used.

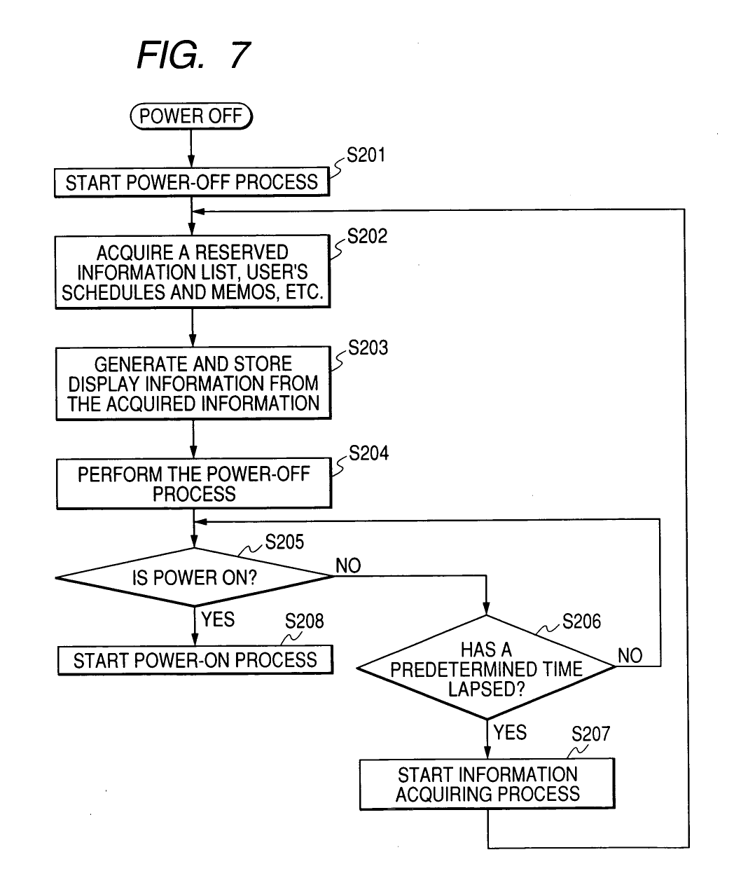

Next, the operation of the recording/reproducing apparatus 100 at the time of powering off the recording/reproducing apparatus 100 will be described. FIG. 7 is a flow chart showing a process at the time of powering off the recording/reproducing apparatus 100. When the user operates a power-off button by using the remote controller 40, the control CPU 104 starts a power-off process (S201).

The control CPU 104 acquires a reserved program information list, user's schedules and memos, etc. from the HDD 105a S202).

Successively, the control CPU 104 collects notice information such as the recording-reservation information list, the user's schedules and memos, etc., generates a file in a format allowed to be displayed at the next time of powering on the recording/reproducing apparatus 100 and stores the generated file in the memory 113 (S203). Incidentally, the file may be stored in the HDD 105a. On this occasion, the file is generated in the form of a bitmapped image or in the form of a HTML text.

When the file to be displayed is stored in the memory 113 at the next time of powering on the recording/reproducing apparatus 100, the control CPU 104 performs a process of powering off the recording/reproducing apparatus 100 (ST204). As the power-off process, the control CPU 104 cuts off the power supply to units large in power consumption such as the DVD unit 105b and the HDD 105a in the recording/reproducing apparatus 100 so that the mode of the control CPU 104 and the remote control receiver 108 serving as a user interface is changed to a low speed operating mode. That is, the recording/reproducing apparatus 100 is not suspended completely.

When the user operates a power-on button by using the remote controller 40 during the period in which the recording/reproducing apparatus 100 is off, the remote control receiver 108 receives a power-on signal and the control CPU 104 detects the received power-on signal (S205). On this occasion, the control CPU 104 starts a power-on process which will be described later (S208).

During the period in which the recording/reproducing apparatus 100 is off, the recording/reproducing apparatus 100 acquires notice information automatically at intervals of a predetermined time. During the period in which the recording/reproducing apparatus 100 is stopping (off), the control CPU 104 always monitors whether a predetermined time has lapsed or not since the previous automatic acquisition of the notice information in accordance with the soft timer (S206). When the predetermined time has lapsed, the recording/reproducing apparatus 100 acquires user information via the network (S207). Contents of the user information and a method for acquiring the user information via the network are similar to those in the step 111 (ST111).

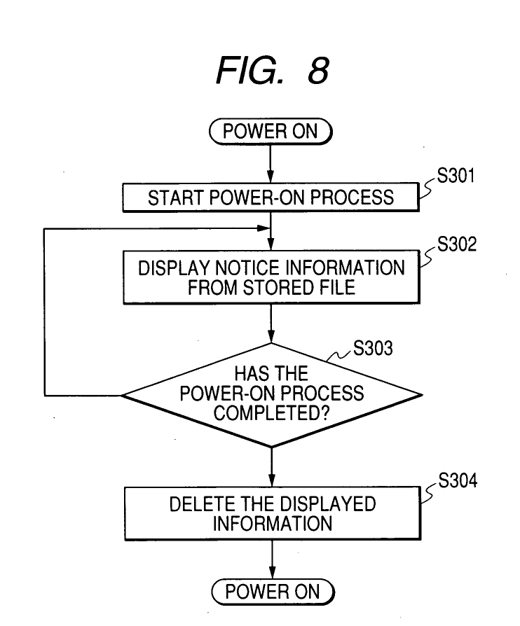

Next, the operation of the recording/reproducing apparatus 100 in the power-on process will be described. FIG. 8 is a flow chart showing the process of the recording/reproducing apparatus 100 when the recording/reproducing apparatus 100 is on. When the control CPU 104 detects a power-on signal during the period in which the recording/reproducing apparatus 100 is off, the power-on process starts (S301).

As the power-on process, a start-up process such as an initializing process is performed while power supply to units and circuits to which power supply has been cut off is resumed. In the HDD 105a which is a large capacity storage device, the work for reading a file system of the HDD is required as the initializing process, so that a relatively long time is taken in accordance with increase in capacity of the HDD.

Therefore, the control CPU 104 reads the display file stored in the memory 113 during the start-up process such as the initializing process at the time of powering on the recording/reproducing apparatus 100 and outputs a picture made up of notice information such as the timer recording information list, the user's schedules and memos, etc. to the picture apparatus 200 to thereby display the notice information on the picture apparatus 200 (S302).

Accordingly, when the user of the recording/reproducing apparatus 100 operates the power-on button by using the remote controller 40, the user can confirm the notice information such as the timer recording information list, the user's schedules and memos, etc. by viewing the notice information immediately after the button operation.

The control CPU 104 judges whether the power-on process proceeding in parallel with display of the notice information (S302) has been completed or not (S303). When the power-on process has not been completed, the display of the notice information (S302) is continued. When the power-on process has been completed, the display of the notice information is suspended (S304).

The display of the notice information can be suspended/deleted not only after the completion of the start-up process of the recording/reproducing apparatus 100 but also after the display of the notice information has been continued for a constant time or by a remote-control key operation.

These pieces of notice information may be displayed in a see-through mode so that original pictures displayed after the completion of the start-up process can be also viewed.

In the embodiment of the invention as described above, when the recording/reproducing apparatus 100 begins to be powered off, notice information such as a list of information reserved in the recording/reproducing apparatus 100, user's schedules and memos, etc. is acquired and the acquired notice information is collected to generate and store a file in a format allowed to be displayed at the time of powering on the recording/reproducing apparatus 100. Moreover, configuration is made so that the display information is updated, at intervals of a predetermined time. Accordingly, the information can be displayed in accordance with the date and time of powering on the recording/reproducing apparatus 100 to thereby make it possible to provide meaningful information.

Incidentally, when the control CPU 104 reads the display file stored in the memory 113 and outputs a picture made up of notice information such as the timer recording information list, the user's schedules and memos, etc. to the picture apparatus 200, the control CPU 104 may cut off past notice information but display notice information made up of only information since the present date and time in accordance with output of the soft timer.

In any case, the user can confirm various kinds of information concerned with the user during the start-up process of the recording/reproducing apparatus. In addition, the user can make good use of the time taken for starting up the recording/reproducing apparatus.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A picture display apparatus comprising:
a user information acquisition unit that acquires user information that is displayed when the picture display apparatus is powered on;
a memory that stores the user information at the time of powering off the picture display apparatus, the user information acquired by the user information acquisition unit; and
a display unit that displays the user information stored in the memory during a start-up process at the time of powering on the picture display apparatus.

2. The picture display apparatus according to claim 1, further comprising:
a broadcast program recording unit;
wherein the user information includes information with respect to timer recording programs to be recorded by the broadcast program recording unit; and
the display unit displays a list of the timer recording programs during the start-up process at the time of powering on the picture display apparatus.

3. The picture display apparatus according to claim 1,
wherein the user information includes information with respect to a schedule of user; and
the display unit displays the schedule of user during the start-up process at the time of powering on the picture display apparatus.

4. The picture display apparatus according to claim 1,
wherein the user information includes information with respect to a memo of user; and
the display unit displays the memo of user during the start-up process at the time of powering on the picture display apparatus.

5. The picture display apparatus according to claim 1,
wherein the user information acquisition unit includes a menu for inputting, changing and deleting schedules and memos of users.

6. The picture display apparatus according to claim 1,
wherein the user information includes information with respect to recorded programs; and
the display unit displays a list of latest recorded programs during the start-up process at the time of powering on the picture display apparatus.

7. The picture display apparatus according to claim 1, further comprising:
an operating unit that operates the user information acquisition unit at intervals of a predetermined time.

8. The picture display apparatus according to claim 1, further comprising;
a file generating unit that generates a file at the time of powering off the picture display apparatus, the file containing information to be displayed when the picture display apparatus is powered on next time;
wherein the memory stores the file; and
the display unit displays the information stored in the file during the start-up process at the time of powering on the picture-display apparatus.

9. The picture display apparatus according to claim 8, further comprising;
a selecting unit that previously selects a type of the user information to be displayed;
wherein the user information acquisition unit acquires the user information that is selected by the selection unit.

10. The picture display apparatus according to claim 1, further comprising: a display setting unit that sets whether the user information is displayed during the start-up process.

11. A picture display apparatus, comprising:
a user information acquisition unit that acquires user information that is displayed when the picture display apparatus is powered on;
a memory that stores the user information at intervals of a predetermined time, the user information acquired by the user information acquisition unit; and
a display unit that displays the user information stored in the memory during a start-up process at the time of powering on the picture display apparatus.

12. The picture display apparatus according to claim 11, further comprising:
a broadcast program recording unit;
wherein the user information includes information with respect to timer recording programs to be recorded by the broadcast program recording unit; and
the display unit displays a list of the timer recording programs during the start-up process at the time of powering on the picture display apparatus.

13. The picture display apparatus according to claim 11,
wherein the user information includes information with respect to a schedule of user; and
the display unit displays the schedule of user during the start-up process at the time of powering on the picture display apparatus.

14. The picture display apparatus according to claim 11,
wherein the user information includes information with respect to a memo of user; and
the display unit displays the memo of user during the start-up process at the time of powering on the picture display apparatus.

15. The picture display apparatus according to claim 1,
wherein the user information includes information with respect to recorded programs; and
the display unit displays a list of latest recorded programs during the start-up process at the time of powering on the picture display apparatus.

16. A picture display apparatus comprising:
a first storage unit that stores a user information;
a user information acquisition unit that acquires user information stored in the first storage unit;
a second storage unit that stores the user information acquired by the user information acquisition unit; and
a display unit that displays the information stored in the second storage during a start-up process at the time of powering on the picture display apparatus.

17. The picture display apparatus according to claim 16,
wherein the first storage unit includes a hard disk drive;
the first storage unit is powered off while the picture display apparatus is powered off;
the second storage unit is powered on while the picture display apparatus is powered off; and the first storage unit is larger in capacity than the second storage unit.
